(19) United States
(12) Patent Application Publication
(10) Pub. No.: US 2018/0183178 A1
(43) Pub. Date: Jun. 28, 2018

(54) CABLE STRESS RELIEVER

(71) Applicant: Ryan BILLARD, Spruce Grove (CA)

(72) Inventor: Ryan BILLARD, Spruce Grove (CA)

(21) Appl. No.: 15/738,988

(22) PCT Filed: Jun. 23, 2016
(86) PCT No.: PCT/CA2016/050740

§ 371 Date: Dec. 21, 2017

Related U.S. Application Data
(60) Provisional application No. 62/183,240, filed on Jun. 23, 2015.

(51) Int. Cl. H01R 13/58

(52) U.S. Cl. CPC H01R 13/5812

(57) ABSTRACT

A cord stress reliever is provided, including a first elongated member comprising a first head portion and a first flexible tail portion; a second elongated member comprising a second head portion and a second flexible tail portion; the first head portion removably securable to the second head portion and shaped to envelop a connector on the cable; the first flexible tail portion removably securable to the second flexible tail portion and shaped to envelop the cable.

### RELATED APPLICATIONS

This application claims the benefit of U.S. Provisional Patent Application No. 62/183,240, which is hereby incorporated by reference in its entirety.

### FIELD OF THE INVENTION

The present invention relates generally to cord and cable protectors, and more particularly to cord and cable protectors that provide stress release for the cord or cable.

### BACKGROUND

Cords and cables are frequently used for a wide variety of purposes. A common challenge with such cords and cables is that to preserve room, they are frequently placed in positions that stress the cable, for example when recharging a phone using a mini USB connector the weight of the phone is often directly on the cable, where the cable meets the mini USB head. Even just the frequent bending of the cable around the head as the cable is placed and removed can cause stress and eventual breakage.

A number of cord and cable protectors are available on the market, but these are designed to protect the cable from external threats and/or hide the cables as they are not considered aesthetically pleasing. Another available cord protector requires an elastic material be melted to conform to the cord, which can be a fire hazard.

### SUMMARY OF THE INVENTION

A cable stress reliever is provided, including: a first head portion and a first flexible tail portion; a second head portion and a second flexible tail portion; the first head portion removably securable to the second head portion to form a head, the head shaped to at least partially envelop a connector on the cable and define an opening to allow the connector to connect; and the first flexible tail portion removably securable to the second flexible tail portion and shaped to envelop a portion of the cable.

The first head portion and the first flexible tail portion may form a first elongated member. The second head portion and the second flexible tail may form a second elongated member. The first elongated member may be removably securable to the second elongated member by friction fit. The first elongated member may include a first plurality of extensions configured to be removably securable to the second elongated member. The second elongated member may comprise a second plurality of extensions configured to be removably securable to the first elongated member.

The first and second elongated members may each include a plurality of ridges to correspond to and receive the second and first plurality of extensions, respectively. At least one of the extensions in both the first and second plurality of extensions may include a partial ring. At least one of the extensions in both the first and second plurality of extensions may include a gripping element placeable to grip the ridge.

A cable stress reliever is provided, including: a first elongated member comprising a head portion and a first flexible tail portion; a second elongated member comprising a head portion and a second flexible tail portion; the first head portion removably securable to the second head portion to form a head, the head shaped to at least partially envelop a connector on the cable; and the first flexible tail portion removably securable to the second flexible tail portion and shaped to envelop a portion of the cable.

### DESCRIPTION OF THE DRAWINGS

FIG. 1 is a perspective view of an embodiment of an cable stress reliever according to the invention.

FIG. 2 is a side view thereof.

FIG. 3 is a top view thereof.

FIG. 4 is a perspective view of an alternative embodiment of the invention, showing a cable stress reliever in an open position.

FIG. 5 is a perspective view of an embodiment of a bottom portion of a cable stress reliever according to the invention.

FIG. 6 is a perspective view of an embodiment of a top portion of a cable stress reliever according to the invention.

FIG. 7 is a perspective view of an embodiment of a head portion of a cable stress reliever according to the invention.

FIG. 8 is a perspective view of an embodiment of the bottom portion of a cable stress reliever as shown in FIG. 5, containing a cable.

FIG. 9 is a top view of the embodiment of a cable stress reliever as shown in FIGS. 5 through 8, containing a cable.

FIG. 10 is a side view of the embodiment of a cable stress reliever as shown in FIG. 9.

FIG. 11 is a perspective view of the embodiment of a cable stress reliever as shown in FIG. 9.

FIG. 12 is a front view of the embodiment of a cable stress reliever as shown in FIG. 9.

FIG. 13 is a back view of the embodiment of a cable stress reliever as shown in FIG. 9.

FIG. 14 is a front perspective view of an alternative embodiment of a cable stress reliever according to the invention, showing the head portion in detail.

FIG. 15 is a detail view of a section of the head portion as shown in FIG. 14.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “cable” or “cord” means an insulated wire or wires having a protective casing for a cable length and a connector, and is usable for transmitting electricity or telecommunication signals.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

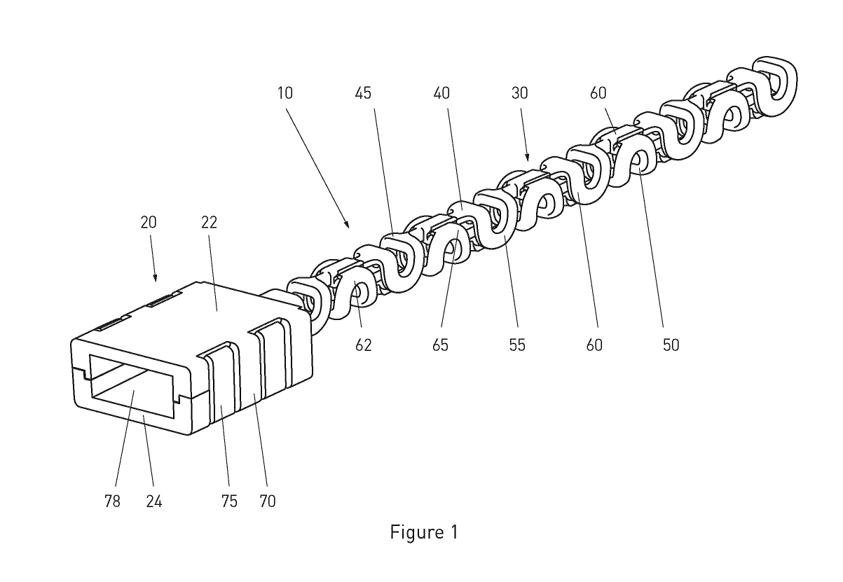

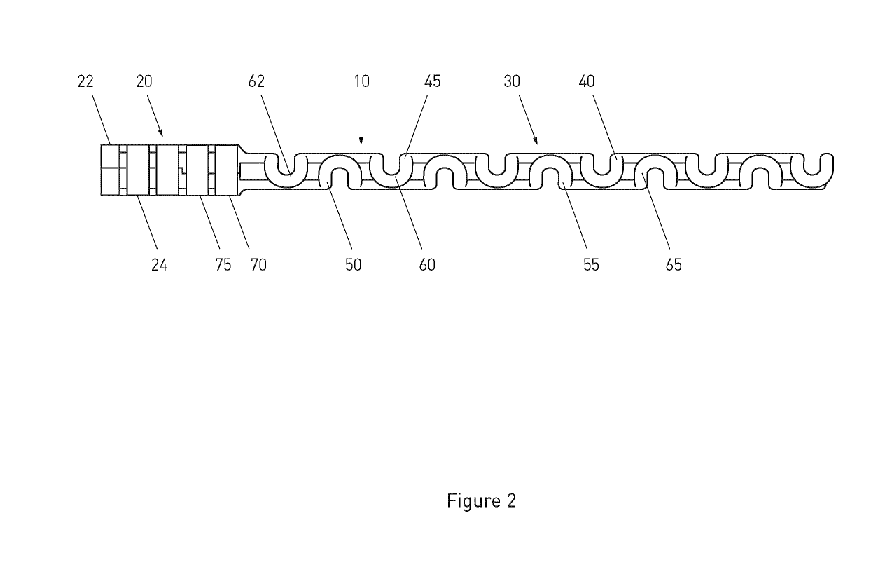

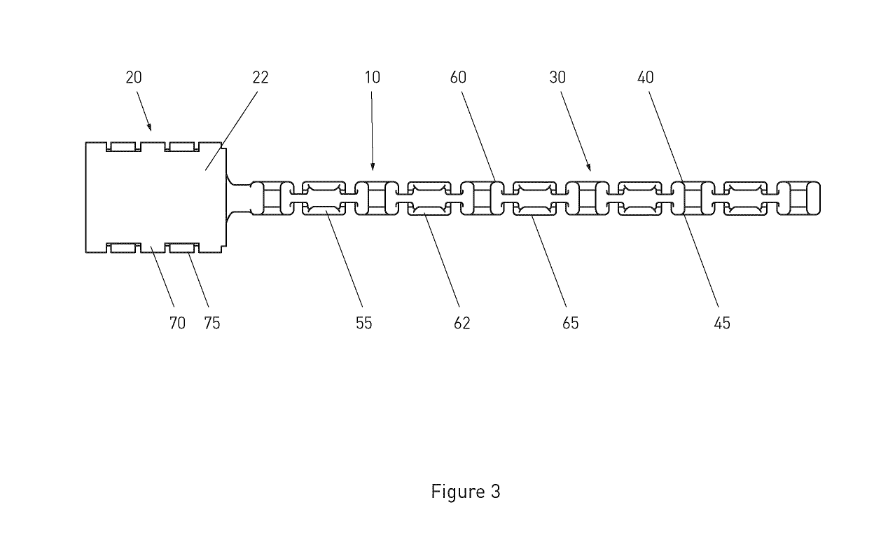

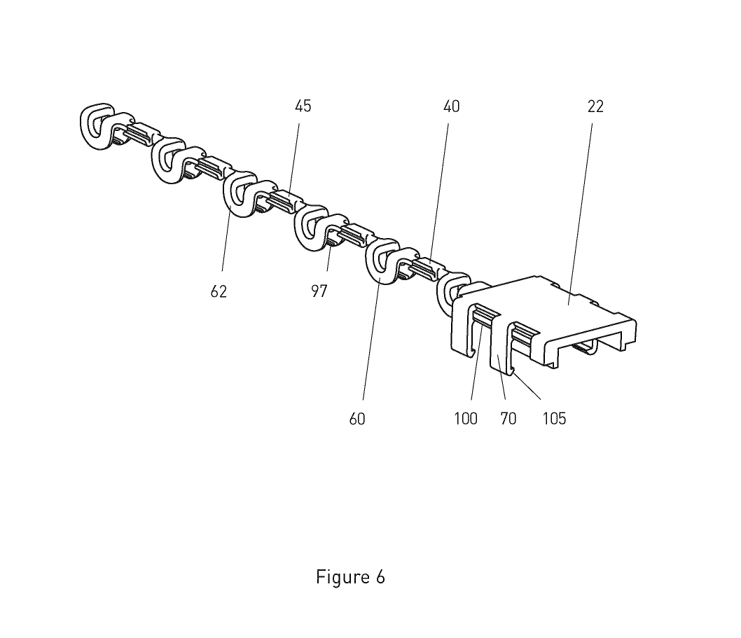

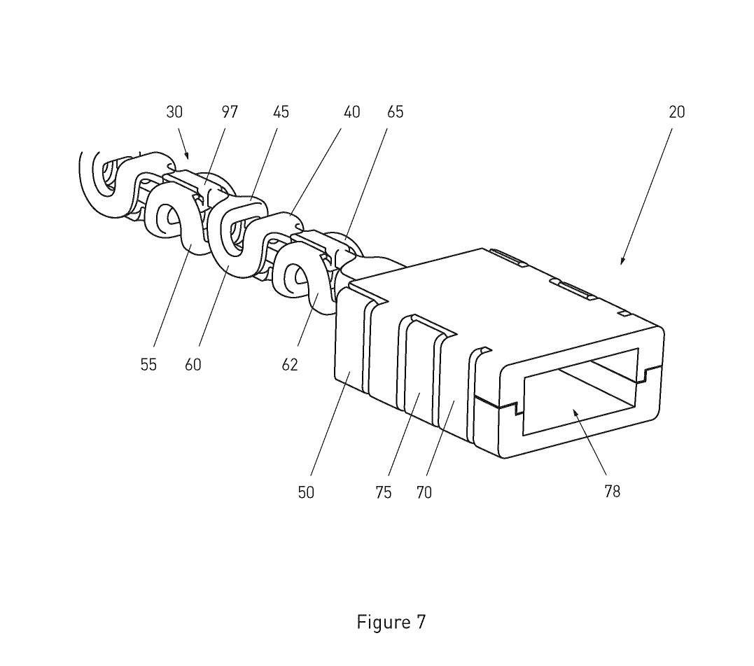

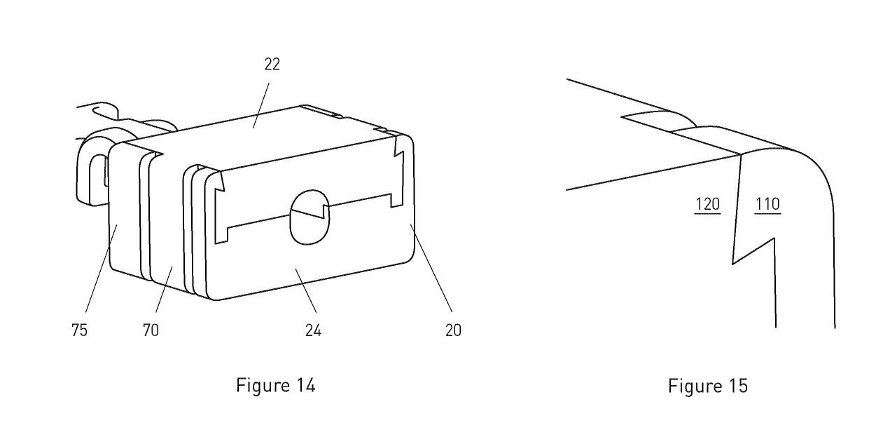

As shown in FIGS. 1 through 15, stress reliever 10 includes head 20 shaped to conform to and cover a connector 28, i.e. the plug or jack, at an end of the cable, and tail 30 shaped to conform to and partially cover at least a portion of a cable length 26 extending from connector 28. As shown in FIGS. 1 through 13, head 20 may be shaped to at least partially cover a USB connector, but in alternative embodiments of the invention, for example as shown in FIGS. 14 and 15, head 20 can be shaped to conform to any type of connector, including, but not limited to Ethernet, USB-mini, USB-B, USB-micro, “phone” type, RCA, barrel, Molex, IEC, JST, pin header, RJ-type, D-sub type, HDMI, and power connectors.

Stress reliever 10 is separable into first portion 40 and second portion 50. First portion 40 and second portion 50 are securable to fit around and at least partially enclose a portion of cable length 26 and connector 28, while exposing an end of the connector to allow the connector to connect to another cable or connection.

First tail portion 45 and second tail portion 55 of tail 30 are configured to be securable to each other and to at least partially surround a portion of cable length 26. A plurality of extensions 60 extend from first tail portion 45 and a plurality of extensions 65 extend from second tail portion 55, and extensions 60, 65 are positioned to hold the second tail portion 55 and the first tail portion 45, respectively. Extensions 60, 65 may be arranged in rows on opposite sides of first and second tail portions 45, 55 respectively, and may be configured to avoid overlap, i.e. an extension 60, when connected to second tail portion 55, may be axially adjacent to an extension 65.

Extensions 60, 65 extending from first tail portion 45 and second tail portion 55 respectively, may connect to second tail portion 55 and first tail portion 45 via a friction fit or via attachment to ridges 95 on first tail portion 45 and second tail portion 55. Ridges 95 are positioned on first tail portion 45 and second tail portion 55 between the extensions 60, 65, on first tail portion 45 and second tail portion 55 to meet and hold extensions 65, 60 extending from second tail portion 55 and first tail portion 45, respectively. Tail 30 may be flexible and bent as needed to accommodate connecting the cable to a connection.

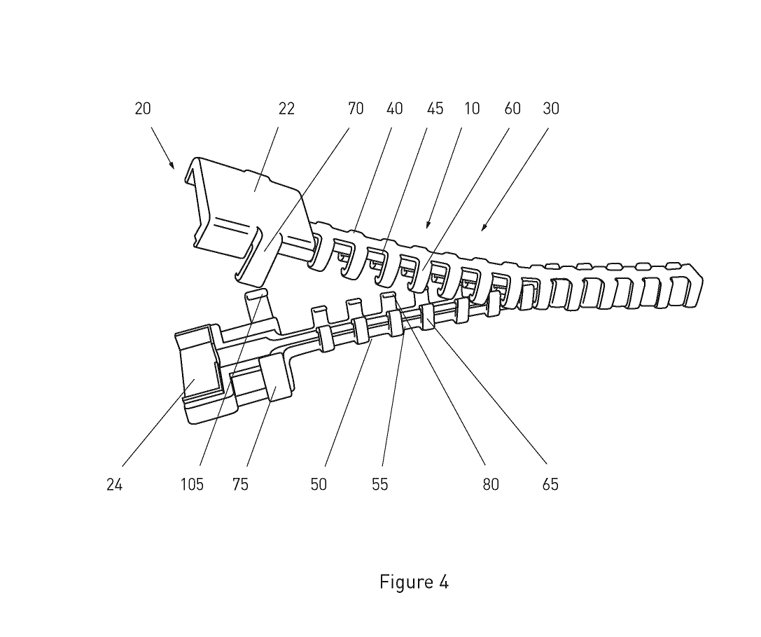

Extensions 60 may be curved elements 62, such as a partial ring as shown in FIGS. 1 to 3 and 5 to 15 and may include gripping element 97; or as shown in FIG. 4, extensions 60 may be straight and include a gripping element 80 to hold the opposite (the first tail portion 45 or second tail portion 55, as appropriate) portion of tail 30.

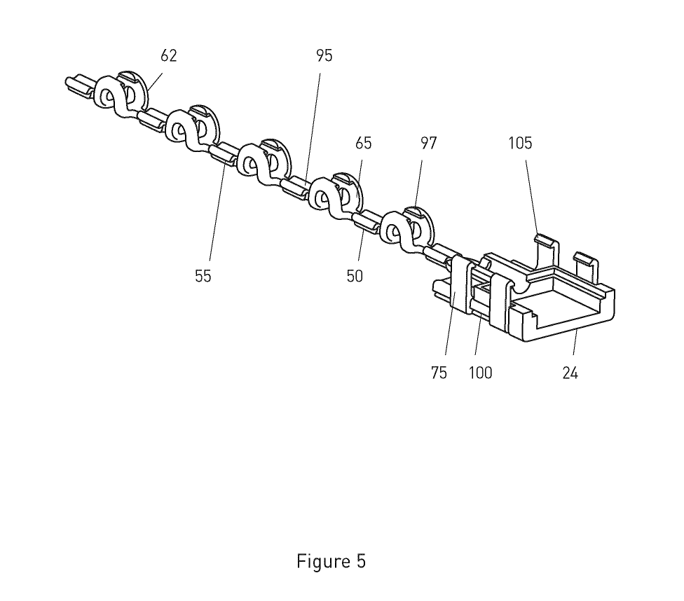

Likewise first head portion 22 and second head portion 24 portions of head 20 are configured to meet and partially cover connector 28 while leaving an opening 78 so that connector 28 can mate with its intended connection. As shown in FIGS. 5 and 6, extensions 70, 75 extend from first head portion 22 and second head portion 24, respectively, and may include gripping members 105 configured to meet and hold ridges 100 on second head portion 24 or first head portion 22, respectively.

In an alternative embodiment of the invention, as shown in FIGS. 14 and 15, extension 75 extending from second head portion 20 may include hooking member 110 shaped to meet and hold recess 120 in first head portion 22.

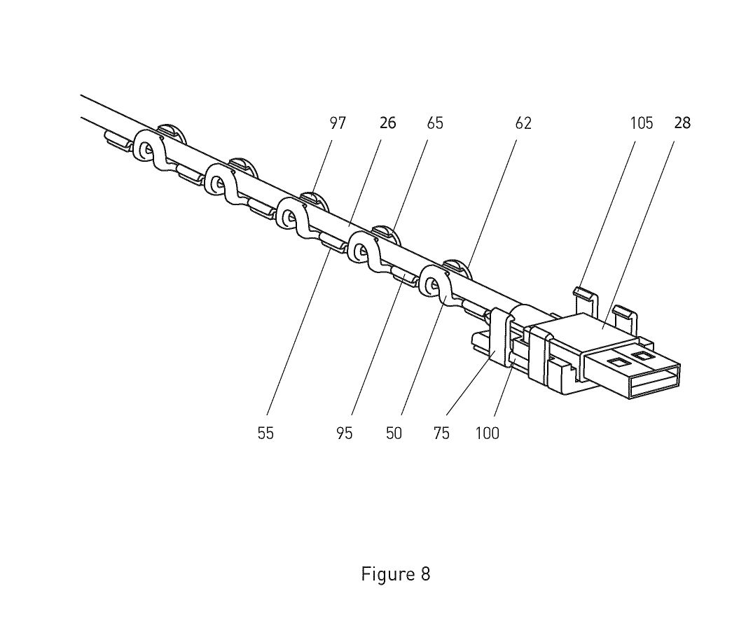

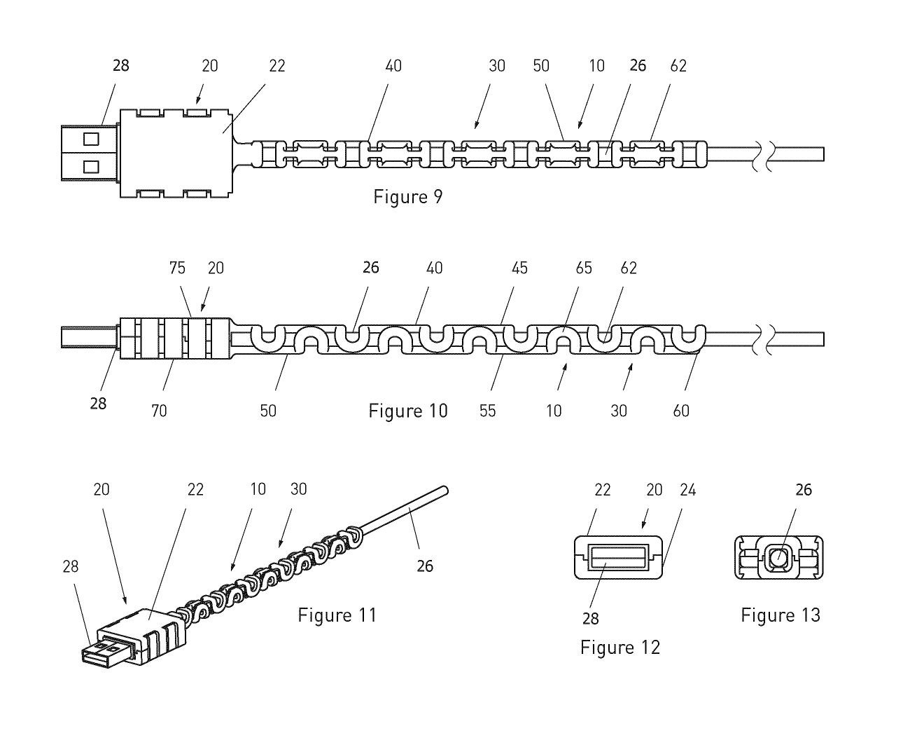

In use, as shown in FIG. 8, first portion 40 is removed from second portion 50 and the cable is placed in second portion 50 with the connector 28 fitted to second head portion 24, and a length of the cable 26 positioned along the second tail portion 55. Once the cable is inserted, first portion 40 is placed on top of second portion 50 and extensions 60, 65 and 70, 75 are used to attach top portion 40 to bottom portion 50, as shown in FIGS. 9 through 13.

Once so attached, the connector 28 on the cable can be connected to an appropriate interface. The flexible tail 30 will only allow the cable length 26 to bend up to a certain angle to the connector, for example up to 90 degrees, and thereby prevent stress on the cable, particularly at the position where the cable length 26 meets connector 28.

Stress reliever 10 may be made of a mixture of silicone, rubber and neoprene although other materials may be used.

Although the particular preferred embodiments of the invention have been disclosed in detail for illustrative purposes, it will be recognized that variations or modifications of the disclosed apparatus lie within the scope of the present invention.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various components described above may omit some components, and/or include other components other than as set out in the illustrated embodiments.

These and other changes can be made to the present embodiments and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form.

I claim:

1. A cable stress reliever comprising:
a first head portion and a first flexible tail portion;
a second head portion and a second flexible tail portion;
the first head portion removably securable to the second head portion to form a head, the head shaped to at least partially envelop a connector on the cable and define an opening to allow the connector to connect; and
the first flexible tail portion removably securable to the second flexible tail portion and shaped to envelop a portion of the cable.

2. The cable stress reliever of claim 1, wherein the first head portion and the first flexible tail portion form a first elongated member.

3. The cable stress reliever of claim 2 wherein the second head portion and the second flexible tail form a second elongated member.

4. The cable stress reliever of claim 3 wherein the first elongated member is removably securable to the second elongated member by friction fit.

5. The cable stress reliever of claim 3 wherein the first elongated member comprises a first plurality of extensions configured to be removably securable to the second elongated member.

6. The cable stress reliever of claim 5 wherein the second elongated member comprises a second plurality of extensions configured to be removably securable to the first elongated member.

7. The cable stress reliever of claim 6 wherein the first and second elongated members each comprise a plurality of ridges to correspond to and receive the second and first plurality of extensions, respectively.

8. The cable stress reliever of claim 7 wherein at least one of the extensions in both the first and second plurality of extensions comprises a partial ring.

9. The cable stress reliever of claim 7 wherein at least one of the extensions in both the first and second plurality of extensions comprises a gripping element placeable to grip the ridge.

10. A cable stress reliever comprising:
a first elongated member comprising a head portion and a first flexible tail portion;
a second elongated member comprising a head portion and a second flexible tail portion;
the first head portion removably securable to the second head portion to form a head, the head shaped to at least partially envelop a connector on the cable; and
the first flexible tail portion removably securable to the second flexible tail portion and shaped to envelop a portion of the cable.
